(19) United States
(12) Patent Application Publication
(10) Pub. No.: US 2024/0190410 A1
(43) Pub. Date: Jun. 13, 2024

(54) Tractor Protection System and Method

(71) Applicant: Bendix Commercial Vehicle Systems LLC, Avon, OH (US)

(72) Inventors: Deepak K. Komandur, San Mateo, CA (US); James Montagna, Strongsville, OH (US); James Michael Cooper, Independence, OH (US); Jeswanth Samayamantula, Andhra Pradesh (IN); Nirav K. Parikh, North Ridgeville, OH (US); Subashish Sasmal, Avon, OH (US)

(73) Assignee: Bendix Commercial Vehicle Systems LLC, Avon, OH (US)

(21) Appl. No.: 18/077,622

(22) Filed: Dec. 8, 2022

(51) Int. Cl. B60T 17/22; B60T 13/26; B60T 13/68

(52) U.S. Cl. CPC B60T 17/227; B60T 13/263; B60T 13/683; B60T 17/221; B60T 2270/406

(57) ABSTRACT

A braking controller causes a tractor protection control module in a tractor to prevent air flow from an air reservoir to a gladhand when the braking controller determines that the trailer is not pneumatically coupled with the gladhand. This prevents air from being vented out the gladhand when the tractor's service brakes are applied. The braking controller can detect pneumatic discontinuity, for example, by receiving a notification from a parking brake controller or from a pressure sensor in the tractor protection control module.

### BACKGROUND

Today's heavy-duty commercial vehicles configured for towing (“tractors”) are normally designed with two isolated braking circuits providing control of a steer axle (or steer axle group) and a rear axle (or rear axle group). Protected and isolated supply and control air signals can be provided from both circuits to a towed vehicle (a “trailer”) to provide braking on the trailer.

### BRIEF DESCRIPTION OF THE DRAWINGS

FIG. 1 is a diagram of a braking sub-system of an embodiment.

FIG. 2 is a diagram of an electronically-controlled tractor protection controller of an embodiment.

FIG. 3 is a flow chart of a method of an embodiment for providing tractor protection.

### SUMMARY

The following embodiments generally relate to a tractor protection system and method. In one embodiment, a tractor protection system is provided comprising a tractor protection controller comprising: an output port configured to be coupled with a braking system of a trailer; an input port configured to be coupled with a reservoir of a tractor; a relay comprising a control port, a source port coupled with the input port, and a drain port coupled with the output port, wherein the relay is configured to selectively allow air to flow between the source port and the drain port in response to a pneumatic signal received at the control port; and a solenoid valve configured to selectively close to prevent a pneumatic signal from being applied to the control port. The tractor protection system also comprises a braking controller configured to cause the solenoid valve to close in response to determining that the output port is not in pneumatic communication with the braking system of the trailer.

In another embodiment, a method is provided that is performed in one or more processors of a tractor. The method comprises determining whether the tractor is pneumatically coupled with a trailer; and in response to determining that the tractor is not pneumatically coupled with the trailer, causing a component in the tractor to prevent control air from being supplied to the trailer.

In yet another embodiment, a system is provided comprising an electronic tractor protection module configured to selectively prevent air flow to a trailer gladhand; and means for causing the electronic tractor protection module to prevent air flow to the trailer gladhand in response to determining that the trailer is pneumatically disconnected from the trailer.

Other embodiments are possible, and each of the embodiments can be used alone or together in combination.

### DETAILED DESCRIPTION

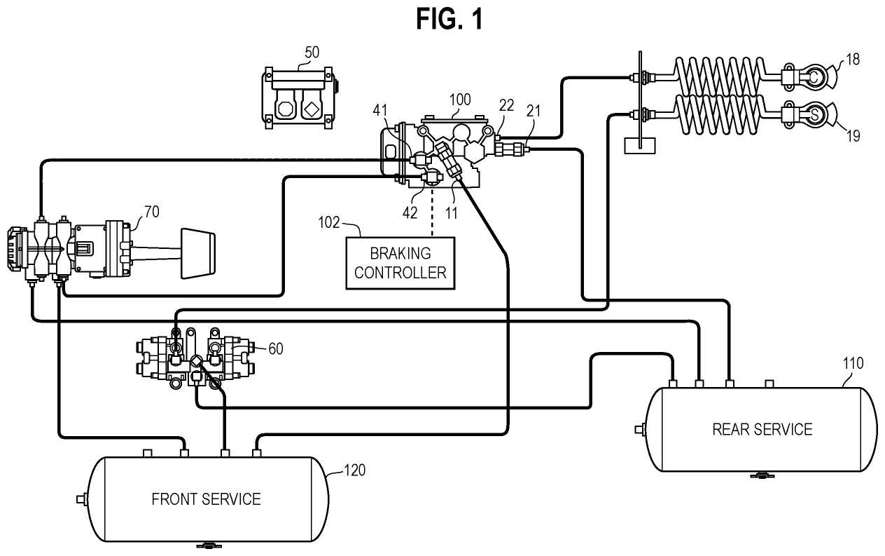

Turning now to the drawings, FIG. 1 is a diagram of a braking sub-system of an embodiment. As shown in FIG. 1, in this embodiment, the braking sub-system comprises a dash control module 50, a park valve module 60, a foot brake module 70, an electronically-controlled tractor protection controller (control module) 100, a braking controller 102, a rear service air reservoir 110, and a front service air reservoir 120. In one embodiment, this braking sub-system is located in a tractor and pneumatically communicates with a braking system of a trailer via gladhands 18, 19. Other components of the vehicle's braking system (such as the tractor's service and parking brakes) are not shown to simplify the drawing.

The rear and front service reservoirs 110, 120 of the braking sub-system are configured to store pressurized air supplied by a compressor (not shown), and the pressurized air in these reservoirs 110, 120 is used to control various braking components on front and rear axles of the tractor to decelerate the tractor. In this embodiment, the rear service reservoir 110 is part of a braking circuit that provides pneumatic pressure to the braking components of the rear axle(s) of the tractor, and the front service reservoir 120 is part of a separate braking circuit that provides pneumatic pressure to the braking components of the front axle(s) of the tractor. Accordingly, the braking system of the tractor of this embodiment has two isolated braking circuits: one providing braking of the rear axle(s) and another providing braking of the front axle(s).

The rear and front service reservoirs 110, 120 are coupled with respective valves in the foot brake module 70 via air hoses (lines) or the like. The foot brake module 70 comprises a brake pedal (e.g., a suspended pedal, where the valve is mounted above the pedal, or a treadle, which pivots directly on the valve mounted below the treadle). Actuation of the brake pedal causes the two valves to open proportional to the amount of actuation of the brake pedal, which caused pneumatic pressure supplied from the rear and front reservoirs 110, 120 to be supplied out of outlet ports of the foot brake module 70 in proportion to the amount of actuation of the brake pedal. The outlet ports of the foot brake module 70 are coupled with service brake components (not shown) of the tractor.

The foot brake module 70 can also provide signals to the braking controller 102 that represent the amount of actuation of the brake pedal. For example, in one embodiment, the foot brake module 70 comprises one or more sensors that measure how much stroke a driver indicates by pressing the brake pedal and transmit electronic signals representing that displacement, which represents a driver brake demand, to the braking controller 102. In one embodiment, the foot brake module 70 contains two sensors, one that increments up and one that increments down as the brake pedal is pressed. These two opposing signals can be used as an error detection mechanism, as the braking controller 102 can detect an error if the two signals it receives from the foot brake module 70 are not opposing. Also, in one embodiment, the foot brake module 70 generates a signal even when the brake pedal is not pressed (such signal would represent zero braking). That way, if the braking controller 102 receives no signal whatsoever from the foot brake module 70, the braking controller 102 can assume there is a fault or error in the foot brake module 70 or communication channel (which, in one embodiment, can be a direct, point-to-point communication channel, such as a universal asynchronous receiver-transmitter (UART) link). It should be understood that any suitable implementation of a foot brake module can be used, and a foot brake module can contain more or different components than those described herein.

This braking sub-system is also used to control braking of the trailer towed by the tractor. In addition to applying pressurized air to the service brakes of the tractor, pressurized air from the foot brake module 70 is also sent to the trailer via gladhand 18 to provide a control signal to actuate brakes on the trailer. In this embodiment, gladhand 19 is used to supply pressurized air from the rear or front service reservoirs 110, 120 to the trailer, and that air is used to apply service braking in the trailer in response to pneumatic control signals received via gladhand 18. Pressurized air from gladhand 19 is also used to release the parking brakes of the trailer. In this embodiment, the trailer has spring brakes that place the trailer in a parked state in the absence of pressurized air. To un-park the vehicle, a driver can cause pressurized air to flow on the service line of gladhand 19, and that air is applied to the spring brakes in the trailer to un-park the trailer. For example, the dash control module 50 can comprise a push-pull button that, when pushed in, causes the park valve module 60 to open. (Another push-pull button on the dash control module 50 can cause the park valve module 60 to apply air to release the spring parking brakes in the tractor.) The park valve module 60 receives pressurize air from the rear and front service reservoirs 110, 120, and the greater pressure is applied from the park valve module 60 in response the push-pull button being pushed in. That air is sent, via gladhand 19, to the trailer to release the spring parking brakes. The park valve module 60 can also detect the pressure being supplied out of gladhand 19. If that pressure is not above a threshold pressure, the valve in the park valve module 60 closes, preventing supply air from being provided out of gladhand 19.

As mentioned above, in addition to un-parking the spring brakes of the trailer, the pressurized air on the service line can be used to actuate the service brakes of the trailer in response to a pneumatic control signal supplied on the control line to gladhand 18. In one embodiment, the pressurized air from gladhand 19 is used to fill reservoir(s) in the trailer, and the pneumatic control signal supplied on gladhand 18 causes air to flow from the reservoir(s) to the braking components on the trailer. As will be discussed below, the tractor protection controller 100 can be used to supply the pneumatic control signal to the trailer and can be used to prevent or control the venting control air when a trailer is not connector to the tractor. This is referred to herein as “tractor protection.”

As shown in FIG. 1, the tractor protection controller 100 comprises inlet ports 41, 42 (with single check valves, not shown) that receive pressurized air from the rear and front service reservoirs 110, 120 in response to actuation of the brake pedal of the foot brake module 70. The tractor protection controller 100 also receives pressurized air from the front service reservoir 120 via port 11 (the pressure from the service reservoirs is proportionally applied). Based on the amount of pressurized air received from the foot brake module 70 and/or control signals from the braking controller 102 for electronic braking, the tractor protection controller 100 causes a proportional amount of pressurized air received from the rear and front service reservoirs 110, 120 to output at port 22, which is coupled with the control line that leads to gladhand 18. This supplied air is the control air sent to the trailer to control the trailer's braking system. The tractor protection controller 100 also comprises port 21, which is coupled with the rear service reservoir 110.

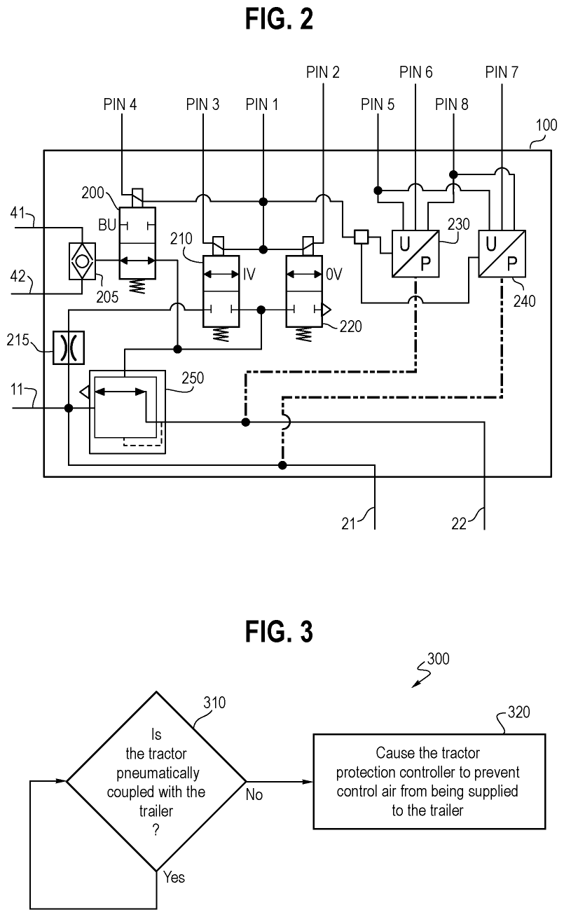

FIG. 2 shows example components of one particular implementation of the tractor protection controller 100. As shown in FIG. 2, the tractor protection controller 100 of this embodiment comprises a double check valve 205, a solenoid backup (BU) valve 200, solenoid input and output valves (IV, OV) 210, 220, a restrictor 215, pressure sensors 230, 240, and a relay 250. The solenoid valves 200, 210, 220 and the pressure sensors 230, 240 are electronically coupled with the electronic braking controller 102. The braking controller 102 can take the form of one or more processors that execute computer-readable program code (e.g., software, firmware) stored in a computer-readable medium to perform the functions described herein. The braking controller 102 can additionally or instead comprise logic gates, switches, an application specific integrated circuit (ASIC), or a programmable logic controller, for example. In this way, the braking controller 102 can be configured with hardware and/or firmware to perform the various functions described herein.

In the default state shown in FIG. 2, the solenoid backup (BU) valve 200 is open, and the solenoid input and output valves (IV, OV) 210, 220 are closed. When electronic braking is used, the braking controller 102 sends an electrical signal on pin 4 of the tractor protection controller 100 to close the solenoid backup (BU) valve 200. This prevents pneumatic pressure received from the foot brake module 70 from reaching the control port of the relay 250. However, as noted above, the foot brake module 70 can provide electrical signals to the braking controller 102 that indicates a level of actuation of the brake pedal. Based on this information, the braking controller 102 can send electrical signals to the various pins of the tractor protection controller 100 to selectively open and closed the solenoid input and output valves (IV, OV) 210, 220 to electronically control the air pressure being supplied to the control port of the relay 250. This provide electronically-controlled braking.

When electronically-controlled braking is not used, the solenoid valves 200, 210, 220 are in the state shown in FIG. 2, allowing pneumatic pressure received from the foot brake module 70 to reach the control port of the relay 205. More specifically, when the tractor protection controller 100 receives pressurized air from the two circuit lines of the foot brake module 70 via ports 41 and 42, the double check valve 205 allows the air of the greater pressures from ports 41 and 42 to flow through the open solenoid backup (BU) valve 200 to the control port of the relay 250.

Whatever the source of the pressurized air, the presence of pressurized air at the control port of the relay 250 causes the relay 250 to open in proportion to the amount of pressurized air received. This causes air received at the source port of the relay 250 to flow out of the drain port of the relay 250, in proportion to the control signal, and out of port 22 of the tractor protection controller 100 to gladhand 18. Pressure sensors 230, 240 measure the pressure at the source and drain, respectively, of the relay 250. That information and related control signals can be communicated to/from the braking controller 102 via the shown pins.

A problem can occur if one or both of the gladhands 18, 19 are not pneumatically coupled with the trailer. This can occur, for example, when the tractor is being operated without a trailer (i.e., in bobtail mode), when the gladhands 18, 19 become disconnected from the trailer, or where there is a hole in the control or supply lines. In that situation, when the driver presses the brake pedal or when the braking controller 102 applies electronic braking, control air would flow out, e.g., of the gladhands 18, 19, into the atmosphere, eventually depleting the air in the rear and front service reservoirs 110, 120. This can result in an insufficient amount of pressurized air in the rear and front service reservoirs 110, 120 to apply service brakes in the tractor and/or cause the tractor or trailer to automatically park.

To address this situation, Federal Motor Vehicle Safety Standard (FMVSS) No. 121 requires a “tractor protection system.” To provide tractor protection on the service line, the park valve module 60 can be configured to output air to the service line only when a pressure on the service line exceeds a threshold that indicates that the trailer is connected, as discussed above. To provide tractor protection on the control line, a mechanical tractor protection value can be employed that uses the service line pressure to open the valve to allow control air to flow. So, if the trailer is present, the park valve module 60 would allow service line air to flow to the tractor protection value, causing it to open to allow the control line air to flow. Conversely, if the trailer is not present, the park valve module 60 would not allow service line air to flow to the tractor protection value, leaving the value in a closed state, which would prevent control line air to flow.

However, there may be disadvantages associated with using a mechanical tractor protection valve to provide tractor protection. For example, the mechanical tractor protection valve can be subject to various mechanical failures, such as the piston being stuck completely or partially open or closed. There can also be difficulties in installing the mechanical tractor protection valve properly.

To address these issues, in one embodiment, the braking controller 102 causes the tractor protection controller 100 to close the solenoid backup (BU) valve 200 when the braking controller 102 determines that the tractor is not pneumatically coupled with the trailer. Closing the solenoid backup (BU) valve 200 prevents air from the foot brake module 70 from reaching the control port of the relay 250 to open the relay 250, thus preventing air from the supply ports 11, 21 from flowing out of the output port 22 of the tractor protection controller 100. Also, because the braking controller 102 knows that the tractor is not pneumatically coupled with the trailer, the braking controller 102 knows not to send signals to the tractor protection controller 100 to cause the solenoid input and output valves (IV, OV) 210, 220 to open to achieve electronic braking.

In this example, because the default state of the solenoid backup (BU) valve 200 is closed, the braking controller 102 “causes” the solenoid backup (BU) valve 200 to close by not sending an electronic signal to cause it to open (or by removing the signal if the valve 200 is open). In other implementations, the solenoid backup (BU) valve 200 may have a default open state or no default state, in which case applying a signal, rather than refraining from applying a signal, would cause the solenoid backup (BU) valve 200 to close.

The braking controller 102 can use any suitable way to determine that the tractor is not pneumatically coupled with the trailer. For example, in one embodiment, the braking controller 102 can be notified by the park valve module 60 or a controller coupled with the park valve module 60 (collectively or individually referred to herein as a “parking controller”) that service air is not being supplied to the trailer. In operation, the park valve module 60 detects the pressure being supplied out of gladhand 19. If that pressure is not above a threshold pressure, the valve in the park valve module 60 closes, preventing supply air from being provided out of gladhand 19. In this situation, the parking controller can notify the braking controller 102 of this situation (e.g., via a controller area network (CAN)). (The driver can also be notified of this situation.) This would cause the braking controller 102 to determine that the tractor is not pneumatically coupled with the trailer.

As another example, the braking controller 102 can determine that the tractor is not pneumatically coupled with the trailer via the source pressure sensor 240 in the tractor protection controller 100. More specifically, if pressurized air is being vented out of one or both of the gladhands 18, 19, the source pressure into the tractor protection controller 100 would drop. By monitoring the reading of the source pressure sensor 230, the braking controller 102 can determine that the tractor is not pneumatically coupled with the trailer in response to the monitored pressure dropping below a threshold.

It should be understood that these are merely examples and that the braking controller 102 can use other ways (e.g., pneumatically, electrically, mechanically, etc.) to determine that the tractor is not pneumatically coupled with the trailer. Accordingly, the details presented herein should not be read into the claims unless expressly recited therein.

Turning again to the drawings, FIG. 3 is a flow chart 300 that shows the operation of the braking controller 102 in one embodiment. As shown in FIG. 3, the braking controller 102 determines whether the tractor is pneumatically coupled with the trailer (act 310). If the braking controller 102 determines whether the tractor is not pneumatically coupled with the trailer, the braking controller 102 causes the tractor protection controller 100 to prevent control air from being supplied to the trailer (act 320).

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A tractor protection system comprising:
a tractor protection controller comprising:
an output port configured to be coupled with a braking system of a trailer;
an input port configured to be coupled with a reservoir of a tractor;
a relay comprising a control port, a source port coupled with the input port, and a drain port coupled with the output port, wherein the relay is configured to selectively allow air to flow between the source port and the drain port in response to a pneumatic signal received at the control port; and
a solenoid valve configured to selectively close to prevent a pneumatic signal from being applied to the control port; and
a braking controller configured to cause the solenoid valve to close in response to determining that the output port is not in pneumatic communication with the braking system of the trailer.

2. The tractor protection system of claim 1, wherein the tractor protection system provides tractor protection without using a mechanical tractor protection valve.

3. The tractor protection system of claim 1, wherein the braking controller is further configured to determine that the output port is not in pneumatic communication with the braking system of the trailer in response to receiving a signal from a parking controller that indicates that supply air is not being provided to the braking system of the trailer.

4. The tractor protection system of claim 1, wherein the tractor protection controller further comprises a pressure sensor located between the input port and the supply port of the relay, and wherein the braking controller is further configured to determine that the output port is not in pneumatic communication with the braking system of the trailer in response to receiving a signal from the pressure sensor that indicates a detected pressure is below a threshold.

5. The tractor protection system of claim 1, wherein the braking controller is further configured to cause the solenoid valve to close by sending an electrical signal to the solenoid valve.

6. The tractor protection system of claim 1, wherein the braking controller is further configured to cause the solenoid valve to close by refraining from sending an electrical signal to the solenoid valve.

7. The tractor protection system of claim 1, wherein the tractor protection controller further comprises a second input port configured to be coupled with a second reservoir of the tractor, wherein the second input port is coupled with the source port of the relay.

8. The tractor protection system of claim 1, wherein the tractor protection controller further comprises at least one additional solenoid valve, and wherein the braking controller is further configured to send electrical signals to the at least one additional solenoid valve to provide electronic braking.

9. A method comprising:
performing in one or more processors of a tractor:
determining whether the tractor is pneumatically coupled with a trailer; and
in response to determining that the tractor is not pneumatically coupled with the trailer, causing a component in the tractor to prevent control air from being supplied to the trailer.

10. The method of claim 9, wherein the control air is prevented from being supplied to the trailer without a use of a mechanical tractor protection valve.

11. The method of claim 9, wherein the one or more processors determine that the tractor is not pneumatically coupled with the trailer in response to receiving a signal that indicates that supply air is not being provided to the braking system of the trailer.

12. The method of claim 9, wherein the one or more processors determine that the tractor is not pneumatically coupled with the trailer in response to receiving a pressure sensor signal that indicate a detected pressure is below a threshold.

13. The method of claim 9, wherein the component comprises a solenoid valve, and wherein the one or more processors cause the component in the trailer to prevent control air from being supplied to the trailer by sending an electrical signal to close the solenoid valve.

14. The method of claim 9, wherein the component comprises a solenoid valve, and where the one or more processors cause the component in the trailer to prevent control air from being supplied to the trailer by refraining from sending an electrical signal to the solenoid valve, which causes the solenoid valve to close or remain closed.

15. The method of claim 9, further comprising causing electronic braking.

16. The method of claim 9, wherein the one or more processors are in a braking controller.

17. The method of claim 9, wherein the component comprises a tractor protection controller.

18. A system comprising:
an electronic tractor protection module configured to selectively prevent air flow to a trailer gladhand; and
means for causing the electronic tractor protection module to prevent air flow to the trailer gladhand in response to determining that the trailer is pneumatically disconnected from the trailer.

19. The system of claim 18, wherein the means for causing comprises a braking controller.

20. The system of claim 18, wherein the electronic tractor protection module comprises a solenoid valve.
